(19) United States
(12) Patent Application Publication
(10) Pub. No.: US 2019/0218634 A1
(43) Pub. Date: Jul. 18, 2019

(54) LASER HEAT-TREATED SHAFT AND METHOD OF MAKING THE SAME

(71) Applicant: Ford Global Technologies, LLC, Dearborn, MI (US)

(72) Inventors: Nathaniel HANSEN, Canton, MI (US); Michael A. KOPMANIS, Monroe, MI (US)

(21) Appl. No.: 15/871,290

(22) Filed: Jan. 15, 2018

(51) Int. Cl. C21D 1/09; B23K 26/00; B23K 26/08; C21D 9/30

(52) U.S. Cl. CPC C21D 1/09; B23K 26/0087; B23K 2201/005; C21D 9/30; B23K 26/0823

(57) ABSTRACT

A method for laser-hardening a shaft for a vehicle includes applying laser light energy in a repeating pattern to a journal surface. The method further includes, responsive to the repeating pattern being applied completely around the shaft, applying laser light energy to the surface in a pattern different than the repeating pattern to form an overlap surface pattern that defines a tapered ramp having a corresponding hardness less than a hardness corresponding to the repeating pattern alone.

### TECHNICAL FIELD

This disclosure relates to laser heat-treated shafts and methods of making the same. More particularly, this disclosure relates to a laser hardening of journal surfaces of a crankshaft or a camshaft having overlap regions.

### BACKGROUND

The manufacture of shafts (such as crankshafts and camshafts) often includes the hardening of certain surfaces to increase mechanical properties at the surfaces. The surface hardening process may form an overlap region. Due at least in part to conduction adjacent to a laser beam spot during surface hardening, the surface at the overlap region may include areas having varying surface hardnesses.

In some instances, after hardening, surface finishing operations may be performed on the shafts. The surface finishing operations may cause material removal to occur at a higher rate at surface areas having a lower hardness as compared to surface areas having a higher hardness. This variable material removal may cause geometric deviations at the overlap region that may affect hydrostatic bearing oil film thickness.

### SUMMARY

In at least one approach, a method for laser-hardening a shaft for a vehicle may include applying laser light energy in a repeating pattern to a journal surface. The method may further include, responsive to the repeating pattern being applied completely around the shaft, applying laser light energy to the surface in a pattern different than the repeating pattern to form an overlap surface pattern that defines a tapered ramp having a corresponding hardness less than a hardness corresponding to the repeating pattern alone.

In at least one approach, an engine may include a shaft rotatable about an axis. The shaft may include a journal defining a journal surface having a first set of laser tracks about a perimeter of the journal surface and axially extending entirely between a first edge and a second edge. The journal surface may also have a second set of laser tracks interleaved with the first set and axially extending from the first edge at variable lengths to define a tapered ramp overlap region.

In at least one approach, a method for laser-hardening a shaft for a vehicle is provided. The method may include, with a laser, applying light energy to a journal surface of the shaft such that the light energy is applied along a first axial length. The method may further include rotatably displacing at least one of the shaft and the laser. The method may further include repeatedly applying light energy along the first axial length and rotatably displacing at least one of the shaft and the laser to effect a repeating pattern having the first axial length. When the repeating pattern has been applied about substantially an entire circumference of the journal surface, the method may include forming an overlap region on the journal surface by, within the repeating pattern, applying light energy to the journal surface along a second axial length, rotatably displacing at least one of the shaft and the laser, and, within the repeating pattern, applying light energy to the journal surface along a third axial length. The second axial length may be less than the first axial length and the third axial length is less than the second axial length.

### BRIEF DESCRIPTION OF THE DRAWINGS

FIG. 1 depicts a schematic view of an example vehicle combustion engine including a crankshaft and a camshaft.

FIG. 2 depicts a perspective view of a crankshaft.

FIG. 3 depicts a perspective view of a camshaft.

FIG. 4 depicts a portion of the crankshaft of FIG. 2 having a first surface hardening pattern.

FIG. 5 depicts a portion of the crankshaft of FIG. 2 having a second surface hardening pattern.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

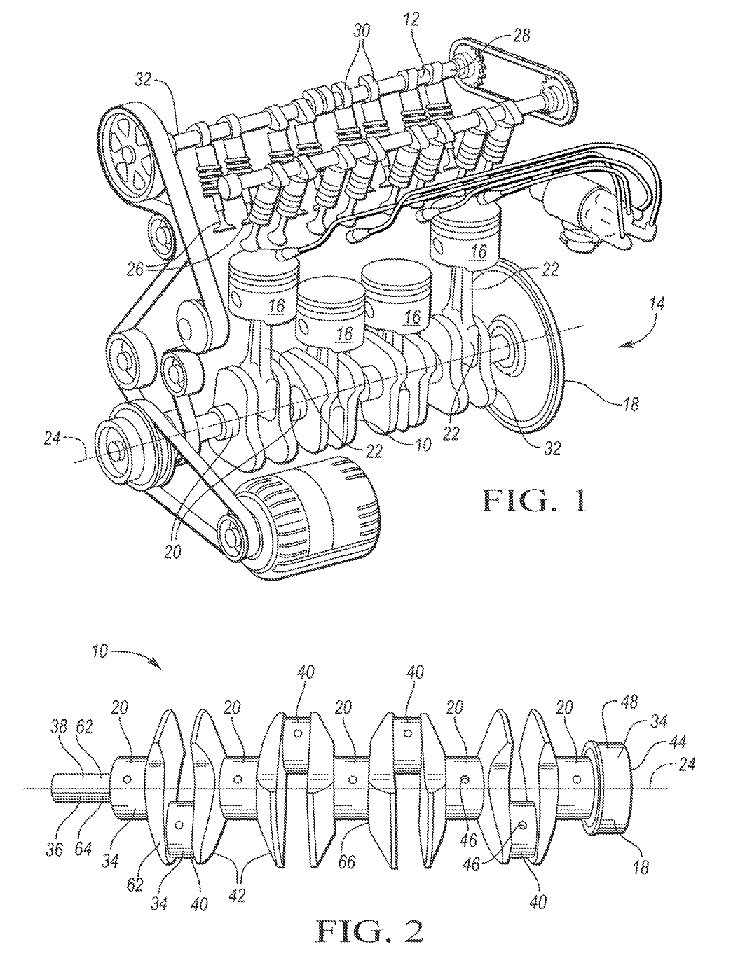

Referring now to FIG. 1, one or more shafts, such as a crankshaft 10 and camshaft 12, may be included as a functional feature of an automotive engine, such as an internal combustion engine 14. A crankshaft 10 may be a mechanical component adapted to perform a conversion between reciprocating motion and rotational motion. In an internal combustion engine 14 of a vehicle, a crankshaft 10 may translate the reciprocating motion of the pistons 16 into rotational motion which enables the wheels to drive a vehicle forward. The crankshaft 10 may be any crankshaft 10 within a cylinder block or within a cylinder head. The crankshaft 10 may be connected to a flywheel 18, an engine block (not depicted) using bearings on a number of main journals 20, and to the pistons 16 via their respective rods 22 so that all pistons 16 of an engine 14 are attached to the crankshaft 10. The crankshaft 10 may regulate the movement of pistons 16 as it moves the pistons 16 up and down inside the cylinders (not depicted). The crankshaft 10 may have a linear axis 24 about which it rotates, typically with several bearing journals 20 riding on replaceable bearings held in the engine block (not depicted).

FIG. 1 further illustrates an exemplary camshaft 12. The camshaft 12 may be any camshaft 12 within the cylinder block or in the cylinder head. A camshaft 12 may be used to operate valves 26 of internal combustion engines with pistons 16. The camshaft 12 may consist of a cylindrical rod 28 running the length of the cylinder bank (not depicted). The camshaft 12 may have one or more lobes 30 protruding from the cylindrical rod 28. For example, the camshaft 12 may have one lobe 30 for corresponding with each valve 26. The lobes 30 may force the valves 26 open by pressing on the valves 26 as they rotate. The camshaft 12 may be linked to the crankshaft 10. For example, as the crankshaft 10 rotates, the camshaft 12 may rotate along with it in a synchronized movement.

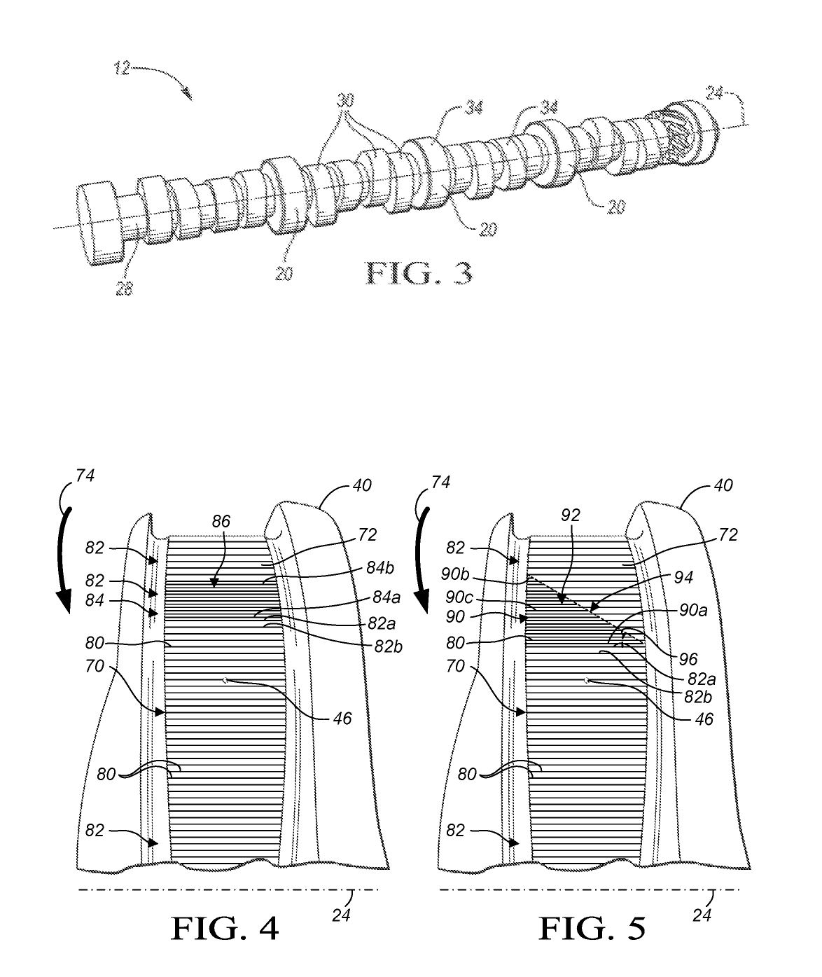

FIGS. 2 and 3 depict non-limiting examples of a crankshaft 10 and a camshaft 12, respectively. Each shaft 10, 12 may include one or more surfaces 34 to be hardened which form a band around a perimeter of a journal.

FIG. 2 depicts an exemplary crankshaft 10 having a post 36 at a first end 38, main journals 20, and pin/rod journals 40 connected to a plurality of counterweights or bearings 42 via undercut regions (not depicted), and a flywheel 18 at a second end 44 opposite the first end. The main journals 20, also called the main bearing journals or fillets, may include an oil hole 46 which may serve for distribution of lubricating oil to the bearings. The pin journals 40, also known as crankpins or crankpin fillets, also may include an oil hole 46. The crankshaft 10 may further include oil ducts for facilitating lubrication, which are not depicted. The crankshaft 10 may further include an oil seal 48 located on the flywheel 18.

FIG. 3 depicts a non-limiting example of a camshaft 12 having a cylindrical rod 28, a plurality of main journals 20, and a plurality of lobes 30.

One or more surfaces of the crankshaft 10 and the camshaft (referred to collectively as “shafts” 32) may be hardened. As depicted in FIGS. 2 and 3, the one or more surfaces 34 to be hardened may include a surface on a main journal 20, a pin journal 40, an oil seal 48, a lobe 30, a running surface 62, or any combination thereof. The number of main journals 20, pin journals 40, oil seals 48, lobes 30, and their respective surfaces to be hardened may differ and may depend on the desirable parameters of the shaft 32 which is being manufactured. A running surface 62 may be any cylindrical or shouldered surface or any surface in contact with a journal such as a bushing surface 64 or a shouldered wall surface 66.

A shaft 32 may be monolithic or assembled from several pieces. For example, a shaft 32 may be forged from a steel bar through roll forging or casting in iron. The manufacturing process may include a number of steps; for example, up to 25 operations, including rough machining of the crankshaft, hardening, grinding or turning, and polishing.

Steel shafts 32 may have hardened journal surfaces to increase their mechanical properties. In one approach, a shaft hardening operation includes an induction hardening process. Induction hardening processes may have inherent drawbacks with respect to journal surface area coverage as induction hardening may cause pattern proliferation and overheating of certain regions due to the nature of the inductive field. Difficulty of managing the physics of an induction field lie in applying it to desired regions while avoiding undesired regions. The current flow around oil holes during the induction hardening process may cause bulging and necking conditions. Additionally, axial locating of inductors may be problematic. Coils and recipes must be designed to prevent both metallurgical damage in the chamfer area and pattern infringement into undercuts. These factors typically result in compromises with respect to hardness, surface coverage, and width of the surface hardening pattern. To obtain a higher percentage of surface coverage, a change in the journal design to a tangential journal design has been proposed. Yet, the design change still results in additional manufacturing compromises related to grinding and polishing.

Additionally, the typical case hardening methods may induce distortion of the shaft. For example, induction hardening may cause 50 to 70 μm distortion or more in the shaft axis. Therefore, it is customary that the amount of material removed in the finishing operation and process positioning errors be accounted for and added to the desired finish case depth. This often requires that the hardening case depth be increased which may be accomplished by increasing heat time and/or power supply current. High frequency induction hardening typically produces a case depth of about 1.5 mm to 3 mm which represents an adequate case depth and enables remanufacturing without subsequent retreating. Yet, the product may require grinding after treating. Thus, the typical case depth before grinding is about 1.5 mm to 3 mm, but the case depth of an induction-hardened crankshaft or camshaft in a finished state may not be less than 0.5 mm. Shallower case depths are difficult to achieve with the induction process due to the level of manageable field strength and quench control.

Furthermore, the finishing process may result in a relative increase in residual tensile stresses. To avoid tensile stresses, lower productivity grind cycles are often employed. To measure absolute stress, costly and time-consuming X-Ray diffraction often must be utilized. Despite these efforts, the grind-harden sequence typically results in some loss of desirable compressive stress. Compressive residual stress in the journal surfaces may help prevent cracks from forming and may generally good for fatigue properties.

The typical hardening methods present additional drawbacks. For example, coils are used for induction hardening. These copper coils may have to be changed any time a new geometry on a journal is introduced. Coils are perishable tooling and often must be regularly replaced or reworked from cycling damage. Such change is often costly and time consuming. Furthermore, a quench fluid and high electromagnetic field used during induction hardening present environmental and health challenges.

Nitriding has a number of disadvantages as well. For example, it is a relatively time-consuming process, taking at least 8 hours. Additionally, the resulting depth of the hardened surface is relatively shallow, about 0.01 mm to 0.015 mm after a minimum of an 8-hour-long process, and the shaft has to be retreated if it is ever reground for service. While deeper depths can be obtained via nitriding, substantially longer time is required to achieve the depths deeper than 0.015 mm. The maximum case depth is limited to about 0.5 mm, and time to achieve this depth is about 120 hours which renders this method impractical for high volume applications. Nitriding also produces an undesirable white layer on the surface of the shaft, requiring removal by polishing of the surface after processing.

Additionally still, crankshaft fatigue strength in journals has traditionally been improved by increasing journal compressive stress via rolling or the above-mentioned induction hardening/nitriding. Yet, a combination of both methods is traditionally not used because the induction hardened martensitic microstructure is brittle, even in a tempered state, prone to cracking, especially when subsequent mechanical fillet rolling loads are applied.

Laser hardening represents an alternative method of hardening precision journal surfaces for enhanced wear properties. In a laser hardening process, light energy from a laser may be applied to a journal surface. The laser hardening may process may include forming a hardening pattern into the journal surface.

In at least one approach, a method for laser-hardening a shaft for a vehicle is provided. The method may include a step of generating a surface hardening pattern (described in greater detail elsewhere herein) from a 3-D model of the shaft 32 to be laser hardened. The method may include a step of programming a microprocessor unit (MPU) to generate the surface hardening pattern. In one or more approaches, the generated surface hardening pattern may include a series of preselected points, a portion of, or the entire surface geometry of the shaft 32. The surface hardening pattern may include one or more surfaces 34 on one or more main journals 20, pin journals 40, lobes 30, oil seals 48, running surfaces 62, or any suitable combination thereof.

The method may include determining dimensions of the surface area to be hardened. The method may include a step of adjusting a spot size of the laser beam according to the dimensions of the surface area to be hardened, specifically the depth and width of the surface area to be hardened. The method may include a step of directing a laser beam from the laser power unit to the surface 34 of the shaft 32 to be laser hardened according to the surface hardening pattern. The method may include adjusting one or more parameters of the surface hardening pattern before and/or during the laser hardening operation.

In one or more approaches, the laser hardening may be facilitated by at least one laser power unit. A plurality of laser power units may be utilized. For example, one laser power unit may be used for tempering the surfaces 34 to be hardened. Such laser could be a lower power laser such as a 1.0 kW laser. The second laser power unit could be a high power laser unit facilitating the hardening. The high power unit could be, for example, a 6.0 kW laser. A laser power unit having a different power may be used, for example any laser having power ranging from 500 W to 50 kW may be suitable. Alternatively, both tempering and hardening may be facilitated by one laser power unit. Alternatively still, tempering may be omitted because the laser microstructure is less than 100% martensitic. The temperature to be achieved during the hardening process should not exceed about 1260° C. to prevent overheating of the shaft material.

The method contemplates using different types of lasers as the heat source for the hardening operation. Exemplary non-limiting examples of suitable lasers include lasers having different types of active gain media. The gain media may include liquid such as dye lasers in which the chemical make-up of the dye determines the operational wavelength. The liquids may be organic chemical solvent such as methanol, ethanol, and ethylene glycol containing a dye such as coumarin, rhodamine, and fluorescein. The gain media may include gas such as CO₂, Ar, Kr, and/or gas mixtures such as He—Ne. The gain medium may be metal vapor such as Cu, HeCd, HeHg, HeSe, HeAg, or Au. The gain media may include solids such as crystals and glass, usually doped with an impurity such as Cr, Nd, Er, or Ti ions. The solid crystals may include YAG (yttrium aluminum garnet), YLF (yttrium lithium fluoride), LiSAF (lithium strontium aluminum fluoride), or sapphire (aluminum oxide). Non-limiting examples of solid-state gain media doped with an impurity include Nd:YAG, Cr:sapphire, Cr:LiSAF, Er:YLF, Nd:glass, or Er:glass. The gain medium may include semiconductors having a uniform dopant distribution or a material with differing dopant levels in which the movement of electrons causes laser action. Non-limiting examples of semiconductor gain media may include InGaAs, GaN, InGaN, and InGaAsP. The laser may be a high power fiber laser created from active optical fibers doped with rare earth ions and semiconductor diodes as the light source to pump the active fibers.

The at least one laser power unit may be connected to the MPU also known as a central processing unit capable of accepting digital data as input, processing the data according to instructions stored in its memory, and providing output. The MPU may include mathematical modeling software which is capable of processing input data. Exemplary input data may include information about a 3-D model of a shaft 32 having surfaces 34 to be hardened; parameters for new geometry such as hardening width, energy balance, or the like; parameters relating to oil holes such as the oil hole radius, offset from the center of a journal, or the like.

Referring to FIG. 4, a hardening pattern 70 may be formed on a journal surface 72. As shown, the journal surface 72 may be a surface of a pin journal 40 of a crankshaft 10. In still other approaches, the journal surface 72 may be a surface on a main journal 20, an oil seal 48, a lobe 30, a running surface 62, or any combination thereof. During a hardening process, the pin journal 40 may be rotated relative to a laser head in the direction indicated by arrow 74. As the pin journal 40 rotates, a laser may scan across the journal surface 72 to form the hardening pattern 70 on the journal surface 72. For example, the laser may apply light energy to the journal surface 72 such that the light energy is applied along various axial lengths. At least one of the shaft and the laser may be rotated relative to the other to produce the hardening pattern 70 about a perimeter of the pin journal 40.

The hardening pattern 70 may include a plurality of laser tracks 80. The laser tracks 80 may be formed as a plurality of parallel bands. Individual bands of the parallel bands may extend along the journal surface 72 in a direction corresponding to an axis of the shaft (e.g., parallel to an axis of rotation such as linear axis 24). Individual laser tracks 80 may extend along the journal surface 72 parallel to, or substantially parallel to, the axis. As used herein, extension of the laser tracks 80 substantially parallel to the axis may refer to a general direction of the axis, with the laser tracks 80 being slightly (e.g., 1°-15°) angularly offset from the axis. In at least one approach, individual laser tracks 80 extend parallel to, or substantially parallel to, adjacent individual laser tracks 80. In still another approach, individual laser tracks 80 intersect adjacent individual laser tracks 80.

The laser tracks 80 may include a first set of laser tracks 82 and a second set of laser tracks 84. The first set of laser tracks 82 may be arranged about an entire perimeter of the journal surface 72. More particularly, the first set of laser tracks 82 may be disposed 360° or more about a central axis of journal (e.g., journal pin 40) on which the hardening pattern 70 is arranged. The first set of laser tracks may include a starting laser track 82a, an ending laser track 82b, and intermediate laser tracks disposed therebetween. The starting and ending laser tracks 82a, 82b may correspond to an order in which a laser produces the first set of laser tracks 82.

The laser tracks of first set of laser tracks 82 may be equally spaced from adjacent laser tracks of first set of laser tracks 82. Furthermore, in at least one approach, the laser tracks of first set of laser tracks 82 may define a constant or substantially constant axial length. The axial length may be, for example, an axial length extending in a direction (e.g., parallel to) the axis of the shaft. In this way, the first set of laser tracks 82 may define a repeating pattern.

In at least another approach, the laser tracks of first set of laser tracks 82 may define a variable axial length, but may extend between common edges of the journal 40 along the circumference of the journal surface. For example, a journal 40 may define opposing undercuts disposed on opposite axial edges of the journal surface 72. In some approaches, the journal surface 72 may define a variable axial length between the opposing undercuts about a perimeter of the journal 40. In this way, the laser tracks of first set of laser tracks 82 may extend between the opposing undercuts and may have variable axial lengths about the perimeter of the journal 40.

The second set of laser tracks 84 may be arranged about less than an entire perimeter of the journal surface 72. Similar to the laser tracks of the first set of laser tracks 82, the laser tracks of second set of laser tracks 84 may define a constant or substantially constant axial length. The axial length may be, for example, an axial length extending in a direction (e.g., parallel to) the axis of the shaft. In at least another approach, the laser tracks of second set of laser tracks 84 may define a variable axial length, but may extend between common edges of the journal 40 along the circumference of the journal surface, as discussed with respect to the laser tracks of first set of laser tracks 82.

The second set of laser tracks 84 may include a starting laser track 84a, an ending laser track 84b, and intermediate laser tracks disposed therebetween. The starting and ending laser tracks 84a, 84b may correspond to an order in which a laser produces the second set of laser tracks 84.

A starting laser track 84a of the second set of laser tracks 84 may be disposed adjacent the ending laser track 82b of the first set of laser tracks 82. The second set of laser tracks 84 may be alternately disposed between laser tracks of the first set of laser tracks. For example, a laser track of the second set of laser tracks 84 may be disposed between two laser tracks of the first set of laser tracks 82. Similarly, a laser track of the first set of laser tracks 82 may be disposed between two laser tracks of the second set of laser tracks 84. In this way, the first and second set of laser tracks 82, 84 may form an overlap region 86 that may be defined, for example, as the region between the starting and ending laser tracks 84a, 84b of the second set of laser tracks 84. The overlap region 86 may be formed, for example, to ensure that an entire circumference of the journal 40 has been subjected to the hardening process.

In at least one approach, subsequent to a hardening process, a shaft 32 may be subjected to a finishing process. The finishing process may be, for example, a polishing process such as a tape polishing process or a stone polishing process. In a tape polishing process, a shoe (e.g., a diamond or resin shoe) may be provided to support a tape (e.g., an abrasive tape). The shoe may be adapted to support the tape against the journal surface 72. The shaft 32 may be rotated and axially oscillated while the shoes and tape are engaged with the journal surface 72. In this way, the tape may remove peak of surface finish from the journal surface 72. The finishing process may be performed to improve wear, load capacity, oil film, and heat transfer at the journal surface 72. The finishing process may also enhance contact bearing ratio (Tₚ, Rₘᵣ) quality. The finishing process may also remove an amorphous stress layer that may have been created by prior grinding operation.

In some approaches, the polishing process may remove material from the journal surface 72 at different rates. This may be due to the formation of the overlap region 86 during the hardening process. More particularly, during the hardening process, the laser, due to conduction, may reheat (and re-temper) a previously-hardened region (e.g. within the first set of laser tracks 82 downstream of the starting and ending laser tracks 82a, 82b). In this way, the overlap region 86 may have a hardness less than the non-overlapped area formed by the first set of laser tracks 82. As described herein, hardness refers to a hardness refers to a hardness scale as measured, for example, on the Knoop, Vickers, or Rockwell hardness scales (e.g., Rockwell C).

Due at least in part to the lower hardness value of the overlap region 86, a polishing process may remove material from the overlap region 86 of the journal surface 72 at a faster rate than material removal at the non-overlapped area formed by the first set of laser tracks 82. This variable material removal rate may cause deviations or anomalies (such as dips) in the overlap region 86 when a common uniform pressure is applied to the journal surface 72. Such anomalies may be small (e.g., in the range of approximately 1 μm to 2 μm). However, such anomalies may affect a hydrostatic bearing oil film thickness at the journal surface 72. In many approaches, oil film thickness on a loaded engine is 1 μm or less. An anomaly may cause shearing of the oil film, which may create intermittent contact and heat, eventually resulting in bearing seizure and potentially catastrophic engine loss. Furthermore, when an anomaly when exists in an axis common with the crankshaft main bearing axis, oil loss from flow and loading of the bearing may decrease the oil film.

Referring now to FIG. 5, a tapered set of laser tracks 90 may be provided to form a modified overlap region 92. The tapered set of laser tracks 90 may be interleaved with the first set of laser tracks 82.

The tapered set of laser tracks 90 may include laser tracks having variable axial lengths. More particularly, the tapered set of laser tracks 90 may extend from a first edge at variable lengths to define a tapered ramp overlap region. For example, a starting laser track 90a of the tapered set of laser tracks 90 may have a starting axial length that may correspond to an axial length of the starting laser track 82a of the first set of laser tracks 82. In another approach, the starting laser track 90a of the tapered set of laser tracks 90 may have a starting axial length that may be less than the axial length of the starting laser track 82a of the first set of laser tracks 82. In this way, the starting laser track 90a may have an axial length that is in the range of 95% to approximately 100% of an axial length of an adjacent laser track.

An ending laser track 90b of the tapered set of laser tracks 90 may have an ending axial length that is less than the starting axial length and an adjacent laser track. More particularly, the ending laser track 90b may have an axial length that is in the range of 0.1% to approximately 5% of an axial length of an adjacent laser track.

Successive laser tracks of the tapered set of laser tracks 90 may have reduced axial lengths (e.g., along axis 24) along an arc of the journal surface 72. For example, a median laser track 90c may have an axial length of less than the starting laser track 90a and greater than the ending laser track 90b.

The starting laser track 90a, the ending laser track 90b, the median laser track 90c, and laser tracks 90 therebetween may axial length that terminate at different axial locations (e.g., along the axis 24). In this way, the tapered set of laser tracks 90 may define a termination region 94. In one approach, the termination region 94 may form an oblique angle 96 with respect to the axis 24. In another approach, the termination region 94 may form an oblique angle 96 with respect to one or more laser tracks of the first set of laser tracks 82. The oblique angle 96 may be in the range of approximately 5° to approximately 60°, in the range of approximately 20° to approximately 40°, or any suitable range. In at least one approach, the oblique angle is approximately 30°.

In at least one approach, the termination region 94 is a substantially linear termination region. In still another approach, the termination region 94 is a curved termination region. In this way, the overlap region 92 may form a substantially parabolic overlap region. The termination region 94 may also, or instead, define a helical overlap region 92.

In at least one approach, the overlap region 92 forms a substantially triangular overlap region (when viewed in a two-dimensional plane). The termination region 94 may define a hypotenuse of the substantially triangular overlap region. The hypotenuse may form an oblique angle in the ranges discussed above.

As shown in FIG. 5, the first set of laser tracks 82 may extend between a first common edge and a second common edge. The first common edge, the second common edge, or both the first common edge and the second common edge may be physical features of the pin journal 40. For example, the first and second common edges may be ridges that may be formed by adjacent grooves of the pin journal 40. In at least one approach, the first common edge and/or the second common edge may not be physical features, but rather, may be common termination regions on the journal surface 72. In this way, laser tracks may extend across less than the entire journal surface 72 and may begin at and/or may terminate at common edges.

Furthermore, individual laser tracks of the tapered set of laser tracks 90 may extend from the first common edge. In at least one approach, the laser tracks of the tapered set of laser tracks 90 and do not extend to the second common edge. In this way, the tapered set of laser tracks 90 may have a termination edge or region different than that of the first set of laser tracks 82.

As described herein, the tapered set of laser tracks 90 may form a ramp or a ramp overlap region. The ramp may have a corresponding hardness less than a hardness corresponding to the repeating pattern (as formed by the first set of laser tracks 82) alone.

In this way, during a subsequent finishing operation, a percentage of the overlap surface area disposed in contact with a finishing tape may be reduced at a given angle of shaft 32 rotation. As such, the tendency of the finishing tape (via a shoe) to induce an anomaly at the overlap region 92 may be reduced.

A reduction of anomalies along the journal surface 72 may improve hydrostatic oil film performance. The overlap region 92 may minimize fluid loss as the pathway for these losses may be spread across the arc length of the journal 40. Because fluid loss may be dispersed. Because an oil film may remain higher and more robust.

The overlap region 92 (as well as overlap region 86) may be strategically located on the journal surface 72. For example, a radial orientation of the overlap region 92 may be disposed in a region in which oil film tends to be relatively thick (e.g., where dynamic oil film may be the greatest). Such regions may be indicative of low-load areas. In at least one approach, the overlap region 92 may be formed proximate an oil hole 46. More particularly, the overlap region 92 may be formed within approximately 30° of the oil hole 46.

In at least one approach, a method for laser-hardening a shaft for a vehicle is provided. The method may include, with a laser, applying light energy to a journal surface of the shaft such that the light energy is applied along a first axial length. The method may further include rotatably displacing at least one of the shaft and the laser. The method may further include repeatedly applying light energy along the first axial length and rotatably displacing at least one of the shaft and the laser to effect a repeating pattern having the first axial length. When the repeating pattern has been applied about substantially an entire circumference of the journal surface, the method may include forming an overlap region on the journal surface by, within the repeating pattern, applying light energy to the journal surface along a second axial length, rotatably displacing at least one of the shaft and the laser, and, within the repeating pattern, applying light energy to the journal surface along a third axial length. The second axial length may be less than the first axial length and the third axial length is less than the second axial length.

The method may further include rotatably displacing at least one of the shaft and the laser and, within the repeating pattern, applying light energy to the journal surface along a fourth axial length, wherein the fourth axial length is less than the third axial length.

In at least one approach, the overlap region may define a substantially triangular overlap region. A hypotenuse of the substantially triangular overlap region may form an angle in the range of approximately 20 degrees to approximately 40 degrees with the repeating pattern. In at least another approach, the overlap region may form a substantially parabolic overlap region.

The method may further include engaging the journal surface with a surface-finishing member. The surface-finishing member may be a tape of a tape polisher or a stone of a stone polisher. Other suitable surface-finishing members are expressly contemplated.

The method may include moving at least one of the shaft and the surface-finishing member relative to the other such that the surface-finishing member engages a first laser track of the overlap region having a first axial length. The first laser track may, for example, correspond to laser track 90b of FIG. 5.

The method may further include subsequently moving at least one of the shaft and the surface-finishing member relative to the other such that the surface-finishing member engages a second laser track of the overlap region having a second axial length greater than the first axial length. The second laser track may, for example, correspond to laser track 90a of FIG. 5.

A method for laser-hardening a shaft for a vehicle may include, with a laser, applying light energy in a repeating pattern to a journal surface. When the repeating pattern has been applied in a substantially 360-degree arc about the shaft, the method may further include applying light energy to the surface in a pattern different than the repeating pattern to form an overlap surface pattern.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A method for laser-hardening a shaft for a vehicle, comprising:
applying laser light energy in a repeating pattern to a journal surface; and
responsive to the repeating pattern being applied completely around the shaft, applying laser light energy to the surface in a pattern different than the repeating pattern to form an overlap surface pattern that defines a tapered ramp having a corresponding hardness less than a hardness corresponding to the repeating pattern alone.

2. The method of claim 1 wherein the repeating pattern is defined by a first set of laser tracks having a first axial length, and wherein the overlap surface pattern includes a second set of laser tracks having axial lengths less than the first axial length.

3. The method of claim 2 wherein individual laser tracks of the first set of laser tracks extends between a first common edge and a second common edge, and wherein individual laser tracks of the second set of laser tracks extend from the first common edge and do not extend to the second common edge.

4. The method of claim 3 wherein individual laser tracks of the second set of laser tracks extend from the first common edge to a termination region, and wherein the termination region extends at an oblique angle relative to individual laser tracks of the first set of laser tracks.

5. The method of claim 2 wherein the second set of laser tracks includes a first overlap laser track having an axial length less than the first axial length and a second overlap laser track having an axial length less than the first overlap laser track.

6. The method of claim 2 wherein individual laser tracks of the second set of laser tracks are disposed in alternating arrangement with individual laser tracks of the first set of laser tracks.

7. The method of claim 1 wherein the overlap surface pattern is formed proximate an oil hole formed in the journal surface.

8. The method of claim 7 wherein the overlap surface pattern is formed within a shaft arc of approximately 30 degrees from the oil hole.

9. The method of claim 1 wherein the tapered ramp is substantially triangular.

10. The method of claim 1 wherein the overlap surface pattern includes:
a first laser track having a first axial length;
a second laser track having a second axial length less than the first axial length;
a third laser track having a third axial length less than the second axial length; and
a fourth laser track having a fourth axial length less than the third axial length.

11. The method of claim 10 wherein the fourth axial length of the fourth laser track is in the range of approximately 0.1% to approximately 5% of an axial length of an adjacent laser track of the repeating pattern.

12. An engine comprising:
a shaft rotatable about an axis and including a journal defining a journal surface having a first set of laser tracks about a perimeter of the journal surface and axially extending entirely between a first edge and a second edge, and a second set of laser tracks interleaved with the first set and axially extending from the first edge at variable lengths to define a tapered ramp overlap region.

13. The engine of claim 12 wherein the shaft is at crankshaft or a camshaft.

14. The engine of claim 12 wherein the tapered ramped overlap region is substantially triangular.

15. A method for laser-hardening a shaft for a vehicle, comprising:
with a laser, applying light energy to a journal surface of the shaft such that the light energy is applied along a first axial length;
rotatably displacing at least one of the shaft and the laser;
repeatedly applying light energy along the first axial length and rotatably displacing at least one of the shaft and the laser to effect a repeating pattern having the first axial length; and
when the repeating pattern has been applied about substantially an entire circumference of the journal surface, forming an overlap region on the journal surface by,
within the repeating pattern, applying light energy to the journal surface along a second axial length, and
rotatably displacing at least one of the shaft and the laser, and
within the repeating pattern, applying light energy to the journal surface along a third axial length, wherein the second axial length is less than the first axial length and the third axial length is less than the second axial length.

16. The method of claim 15 further comprising:
rotatably displacing at least one of the shaft and the laser; and
within the repeating pattern, applying light energy to the journal surface along a fourth axial length, wherein the fourth axial length is less than the third axial length.

17. The method of claim 16 further comprising:
rotatably displacing at least one of the shaft and the laser; and
within the repeating pattern, applying light energy to the journal surface along a fifth axial length, wherein the fifth axial length is less than the fourth axial length.

18. The method of claim 15 wherein the overlap region defines a substantially triangular overlap region.

19. The method of claim 18 wherein a hypotenuse of the substantially triangular overlap region forms an angle in the range of approximately 20 degrees to approximately 40 degrees with the repeating pattern.

20. The method of claim 18 further comprising:
engaging the journal surface with a surface-finishing member;
moving at least one of the shaft and the surface-finishing member relative to the other such that the surface-finishing member engages a first laser track of the overlap region having a first axial length; and
subsequently moving at least one of the shaft and the surface-finishing member relative to the other such that the surface-finishing member engages a second laser track of the overlap region having a second axial length greater than the first axial length.
